(19) United States
(12) Patent Application Publication
(10) Pub. No.: US 2017/0029261 A1
(43) Pub. Date: Feb. 2, 2017

(54) SYSTEM FOR FILLING LIQUID CONTAINING BOTTLES

(71) Applicant: SPRAYING SYSTEMS CO., Wheaton, IL (US)

(72) Inventor: Paul Sebern, St. Charles, IL (US)

(21) Appl. No.: 15/225,359

(22) Filed: Aug. 1, 2016

Related U.S. Application Data
(60) Provisional application No. 62/199,738, filed on Jul. 31, 2015.

(51) Int. Cl. B67C 7/00; B67C 3/00; B67C 3/24

(52) U.S. Cl. CPC B67C 7/0006; B67C 3/24; B67C 3/007; B67C 2007/0066

(57) ABSTRACT

A system for efficiently filling liquid containing bottles having removable and replaceable threaded screw tops. The system includes a bottle spindle mechanism having a bottle receiving receptacle, and a liquid dispensing head movable between a raised position for enabling placement and removal of bottles into and from the receptacle with the screw tops in place and lowered liquid dispensing position. With a bottle in the receptacle, the receptacle and bottle are rotatable in one rotary direction while the screw top is manually retained against rotation for unscrewing and removing the screw top; the dispensing head is then lowered to the liquid dispensing position for filling the bottle; the dispensing head then is raised and the screw top repositioned on the bottle; and the receptacle and bottle are rotated in an opposite direction while the screw top is retained for rescrewing the screw top on the bottle.

### CROSS-REFERNCE TO RELATED APPLICATION

This patent application claims the benefit of U.S. Patent Application No. 62/199,738, filed Jul. 31, 2015, which is incorporated by reference.

### FIELD OF THE INVENTION

The present invention relates to liquid container filling systems, and more particularly, to a system for individually filling reusable bottles having a spray head or the like screwed onto the top of the bottles with determined quantities of liquid for reuse of the refilled bottles.

### BACKGROUND OF THE INVENTION

In many commercial establishments, it is necessary to refill bottles or like containers with liquids or chemicals on a daily basis. In hotels, for example, the room cleaning staff commonly uses one liter bottles of liquid cleaners, such as sodium hydroxide, for surface cleaning in bathrooms, night stands, and the like, and liquid sanitizers, such as hypochlorous acid, for sanitizing toilets, bathroom fixtures and the like. In large hotels, such as 4000 and 5000 room hotels, the cleaning staff each day can use 600 or more one liter bottles of liquid cleaners and 300 hundred or more bottles of liquid sanitizer. In such establishments, it is common practice to refill the bottles on a daily basis for reuse. This can be a highly time consuming, and hence, a relatively expensive endeavor. Manual filling of individual bottles with cleaning fluids for prolonged periods also can expose workers to irritating, if not harmful, fumes from the liquids being dispensed.

While systems are available for simultaneously filling a multiplicity of reusable bottles or containers with cleaning fluids and sanitizers, such as disclosed in International application serial number PCT/US2015/063411 filed on Dec. 2, 2015, assigned to the same assignee as the present application, the bottles typically have a spray head that must be removed by unscrewing prior to refilling, and then reassembled on the refilled bottle. This alone can be tedious and time consuming, significantly increasing the time of the refilling process. Moreover, since multiple bottle filling systems can be relatively costly, the need exists, particularly for smaller users, for a system for more efficiently and economically refilling individual bottles or containers having screw top spray heads or the like.

### OBJECTS AND SUMMARY OF THE INVENTION

It is an object of the present invention to provide a system for more efficiently and quickly filling individual bottles or like containers with cleaning fluid or other liquids, such as used in hotels and other commercial establishments.

Another object is provide a bottle filling system as characterized above that can be used for refilling bottles at a rate comparable to, or more quickly, than more expensive and complex systems for filling multiple bottles.

A further object is to provide a bottle filling system of the foregoing type that eliminates the necessity for manually unscrewing and rescrewing spray heads on bottles before and after a refilling operation.

Another object is to provide a system for individually filling bottles of the foregoing type which minimizes exposure to the operator of irritating or harmful fumes of cleaning fluids or other liquids during the refilling process.

A further object is to provide a bottle filling system of the above kind that is operable for quickly removing and replacing screw on spray heads or the like on bottles as an integral part of the refilling process.

Still another object is to provide a bottle filling system of the foregoing type that is relatively simple in construction and lends itself to economical manufacture.

Yet a further object is to provide a system for more quickly removing and replacing screw top spray heads or the like from reusable containers that is usable in conjunction with systems for filling multiplicities of reusable bottles or containers.

Other objects and advantages of the invention will become apparent upon reading the following detailed description and upon reference to the drawings.

### BRIEF DESCRIPTION OF THE DRAWINGS

FIG. 1 is a partially broken away perspective of an illustrative bottle filling system in accordance with the invention;

FIG. 2 is an enlarged broken away perspective of a bottle spindle mechanism of the illustrated bottle filling system for facilitating removal and replacement of screw top spray heads from bottles that are to be refilled;

FIG. 3 is a side elevational view of the bottom of the illustrated bottle filling system;

FIG. 4 is an enlarged, partially broken away, perspective of a liquid dispensing head of the illustrated bottle filling system;

FIG. 5 is a perspective of an underside of the liquid dispensing head shown in FIG. 4;

FIGS. 6-12 are sequential views depicting the use of the illustrative bottle filling system; and

FIG. 13 is a perspective of an alternative embodiment of a bottle spindle mechanism usable in connection with systems for filling multiplicities of bottles with liquid.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE PREFERRED EMBODIMENTS

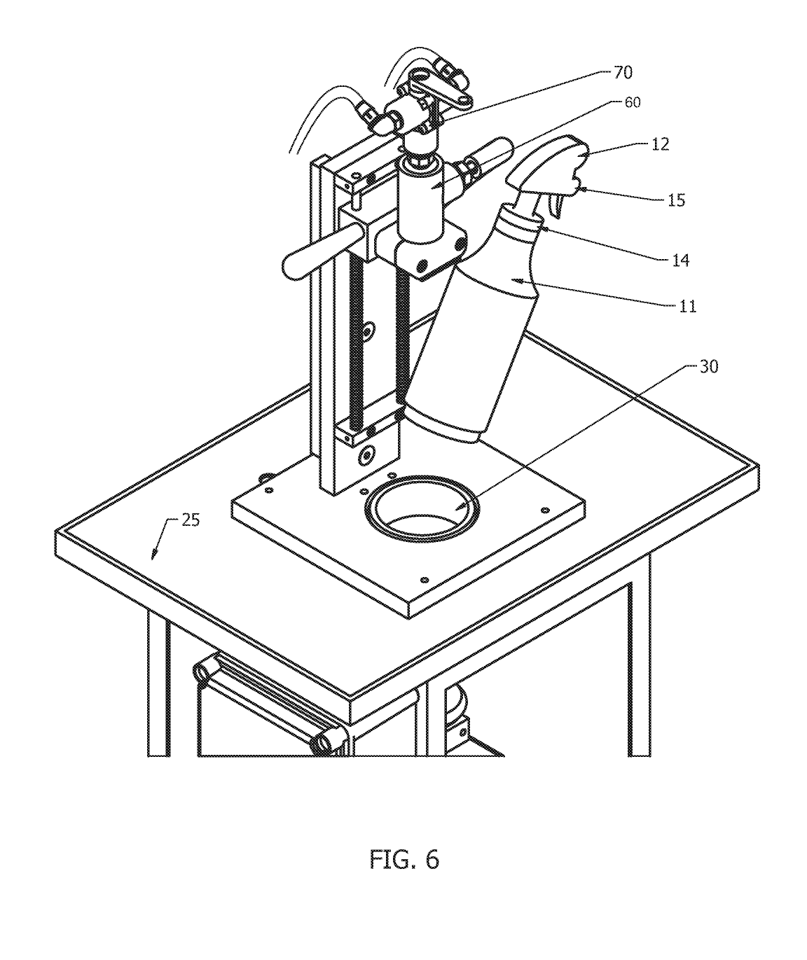

Referring now more particularly to the drawings, there is shown an illustrative bottle filling system 10 in accordance with the invention operable for refilling individual bottles 11 with cleaning fluids or other liquids that are dispensed from the bottles 11 and which are then refilled for reuse. The illustrated bottles 11 have screw top spray heads 12 (FIGS. 6-12) of a conventional type comprising an internally threaded cap 14 screwed on to the upper end of the bottle 11 and a trigger actuated spray nozzle 15 or the like for dispensing liquids form the bottle in a spray form. It will be understood that the term “bottle” is broadly used to encompass bottles and other liquid containing vessels.

The illustrated bottle filling system 10 basically comprises a frame 19, a bottle spindle mechanism 20 for facilitating removal and replacement of screw top spray heads 12 from and onto bottles 11 to be refilled, and a liquid dispensing mechanism 21 for directing liquid into the bottles during refilling. The frame 19 comprises a lower frame structure 24 that supports a horizontal table 25 in elevated relation to the surface upon which the system is mounted. In this case, a platform plate 26 is fixedly mounted centrally on the table 25 and an upstanding ledge 28 is fixed about the periphery of the table 25 for containing any liquid that may accidentally spill during a refilling operation.

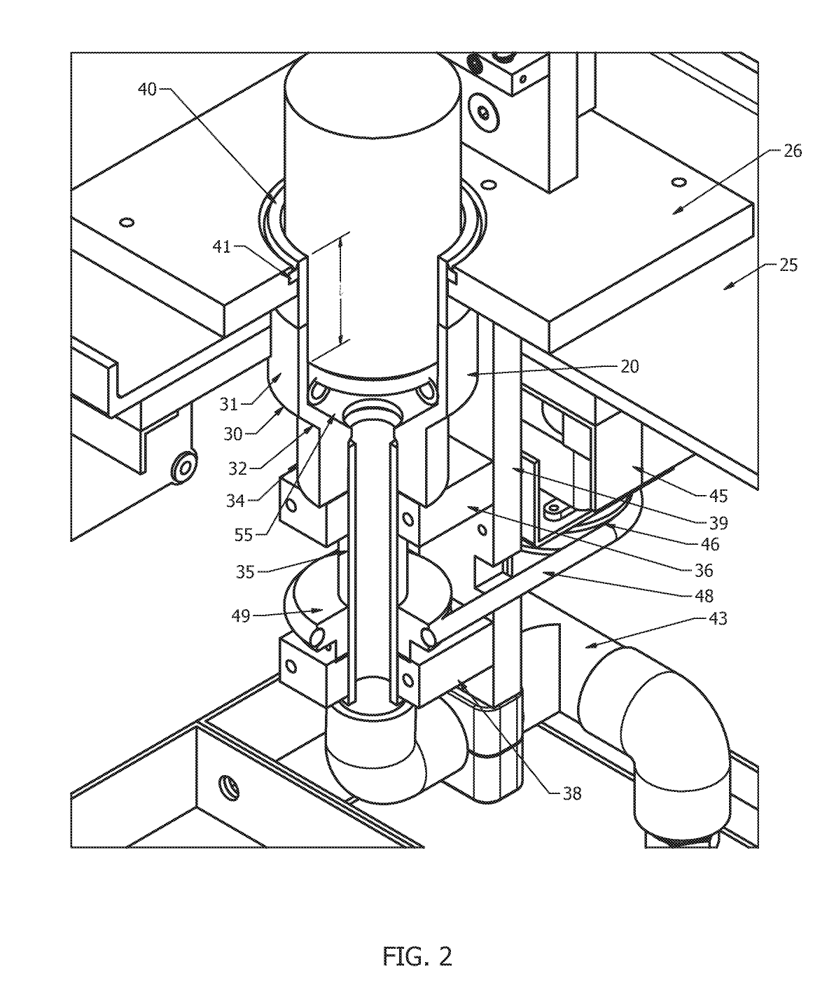

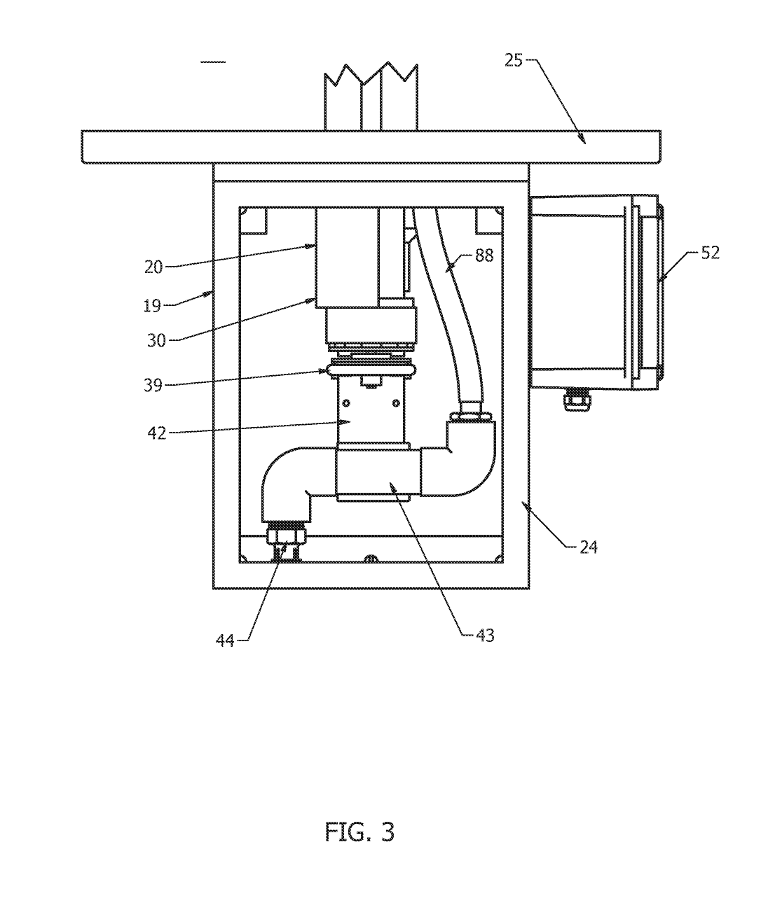

In keeping with the illustrated embodiment, the spindle mechanism 20 comprises a rotatable bottle receiving receptacle 30 mounted in central depending relation to the table 25 for relative rotation. The receptacle 30 in this case has an upwardly opening cylindrical section 31 having a diameter slightly larger than the diameter of the bottle 11 to be filled with liquid, a middle inwardly tapered hollow section 32, and a bottom annular hub section 34 (FIG. 2). A tubular drive shaft 35 is fixedly supported in depending relation to the bottom hub section 34.

For supporting the receptacle 30 for rotation, the depending tubular drive shaft 35 is mounted in a pair of conventional pillow blocks 36, 38 horizontally secured to a support plate 39 fixed in depending relation to the table 25 (FIG. 2). An upper perimeter of the rotatable receptacle 30 has an outwardly flared flange 40 disposed in overlying relation to the platform plate 26 with an annular bushing 41 interposed therebetween for facilitating relative rotation of the receptacle 30 while preventing migration of liquid that may spill upon the table. The lower end of the tubular drive shaft 35 in this instance is disposed within an upwardly opening end of 90 degree elbow 42 for relative rotation. As will become apparent, if any liquid should spill over from the bottle down into the receptacle 30 during a refilling cycle, it will drain through the tubular drive shaft 35 and into the elbow 42. In the illustrated embodiment, the elbow 42 drains to a drain pipe 43 having a drain outlet 44.

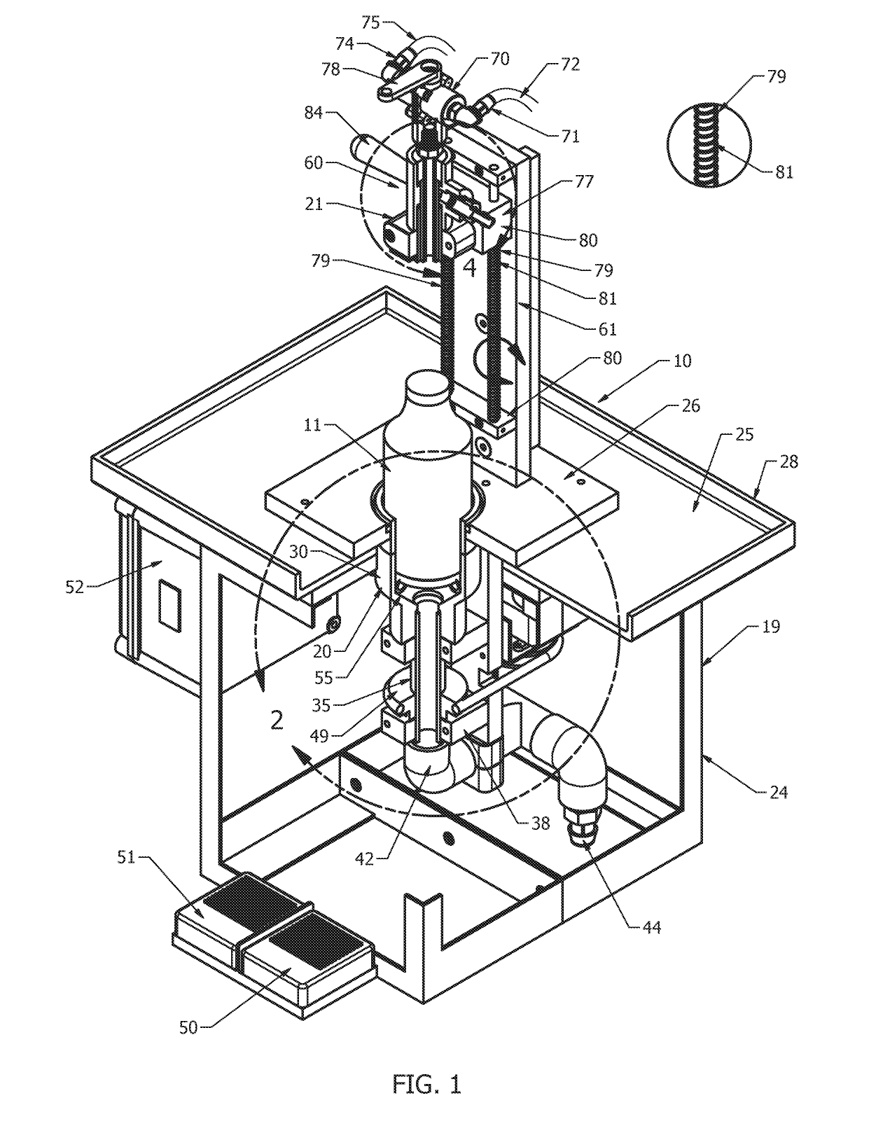

For selectively rotating the bottle receiving receptacle 30, a reversible gear motor 45 of a conventional type is supported under the table 25 which through a drive pulley 46 and belt 48 drives a pulley 49 carried by the tubular drive shaft 35 of the receptacle 30 (FIG. 2). The gear motor 45 in this instance is operated by a pair of foot pedals 50, 51 electrically coupled to the gear motor 45 by a control box 52 (FIG. 1). Operating the right foot pedal 50 in this instance directly operates the gear motor 45 in a manner for rotating the receptacle 30 in a counterclockwise direction, as viewed from above, and actuating the left foot pedal 51 operates the gear motor 45 by way of a reversing relay in the control box 52 for rotating the receptacle 30 in an opposite or clockwise direction.

For facilitating rotation of a bottle 11 simultaneously with the receptacle 30, a bottle gripping frictional element, in this case in the form of a resilient o-ring 55, is disposed at a bottom of the cylindrical section 31 for contact with and support of the bottom of a bottle 11 positioned the receptacle 30. The o-ring 55 in this case is supported at the top of an internal tapered wall of the middle tapered section 32 of the receptacle 30. The illustrated o-ring 55 has a hollow donut shape and may be made of a low durometer PVC or other plastic material that deforms and frictionally engages an underside of a bottle 11 positioned within a receptacle 30 and pressed against the o-ring 55. The bottle 11 preferably is supported within the receptacle 30 such that an axial length l of the cylindrical section 31 of the receptacle 30 surrounding the bottle 11 is at least ⅓ the height of the bottle for maintaining vertical alignment of the bottle during removal and replacement of the screw top spray head 12, as will become apparent, as well as during dispensing of liquid during a liquid refilling operation. In a typical embodiment, the cylindrical section 31 may have an axial length “l” of 3½ inches for supporting a bottle 11 having a height of about 8 inches without the screw top spray head 12.

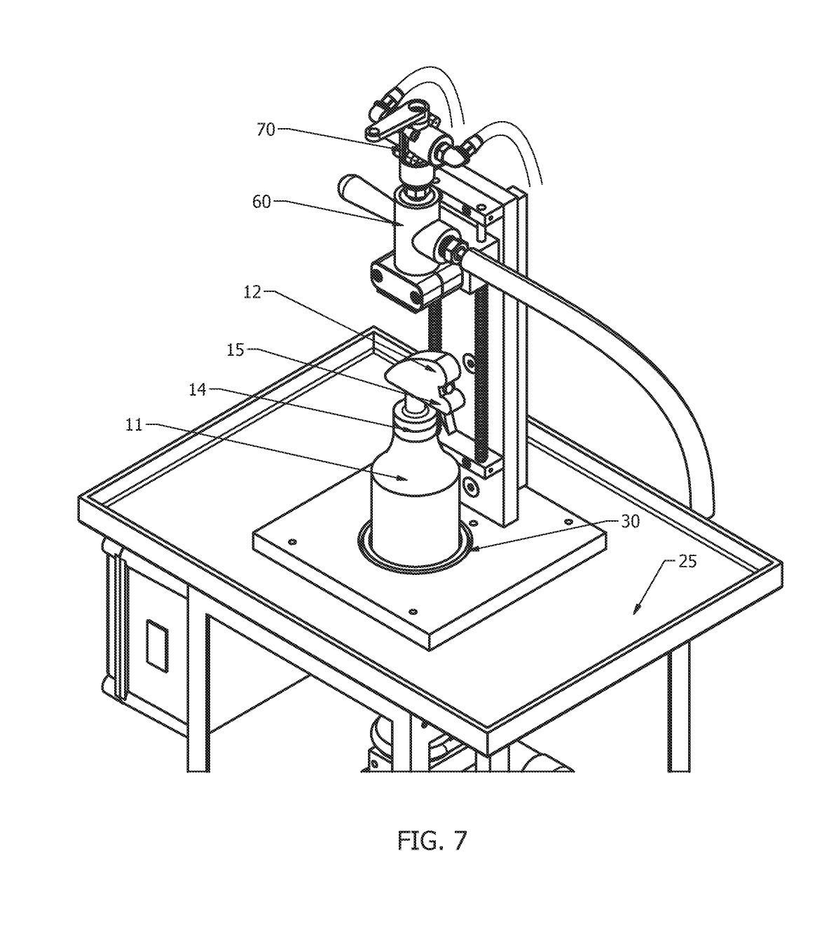

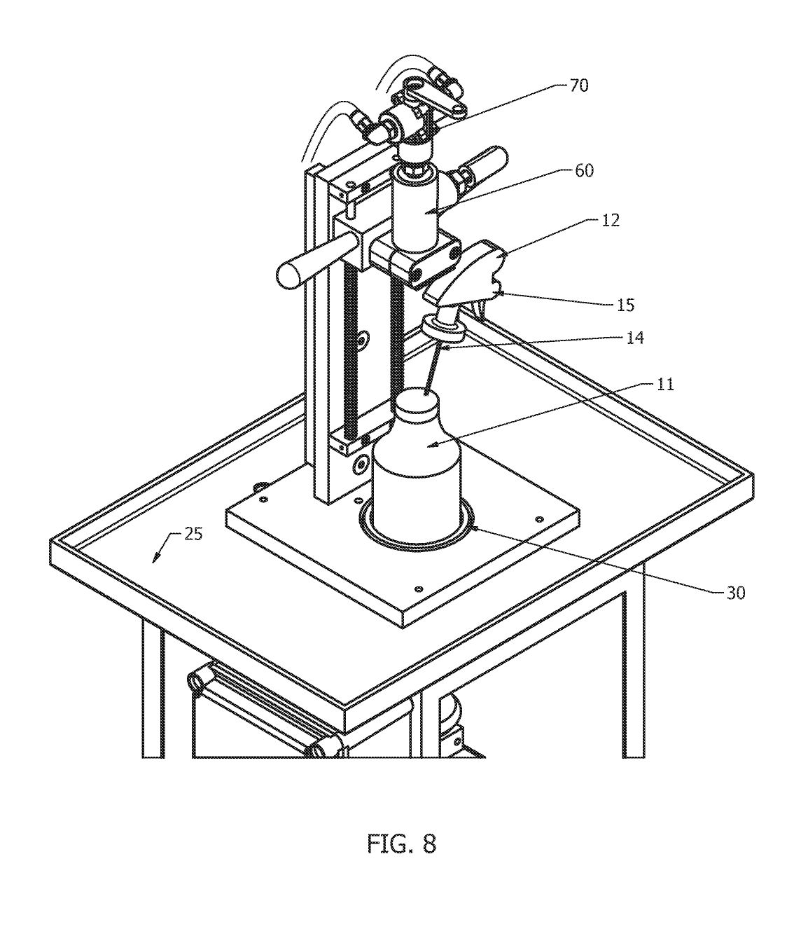

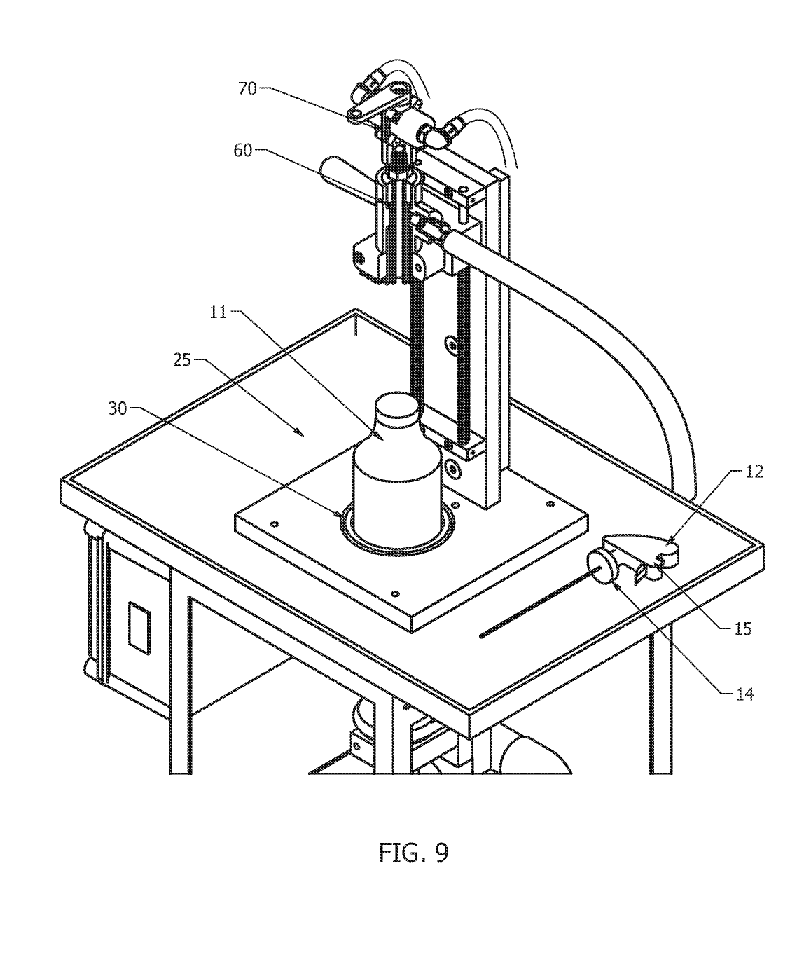

During a bottle refilling operation, it can be seen that an empty bottle 11 with its screw top spray head 12 in place may be positioned into the rotatable receptacle 30 (FIGS. 6 and 7). By gripping the annular cap 14 of the spray head 12, the operator can apply downward pressure on the bottle 11 against the frictional o-ring 55. The operator may then depress the left peddle 57 for causing the receptacle 30 and the bottle 10 held therein to rotate in a clockwise direction, automatically causing the bottle 10 to unscrew from the spray head 12 which is held against rotation by the operator. When the spray head 12 disengages form the bottle 11, the operator may release the foot pedal 51 and place the removed spray head 12 aside (FIGS. 8 and 9). As will become apparent, such spray head removal can be quickly and easily accomplished.

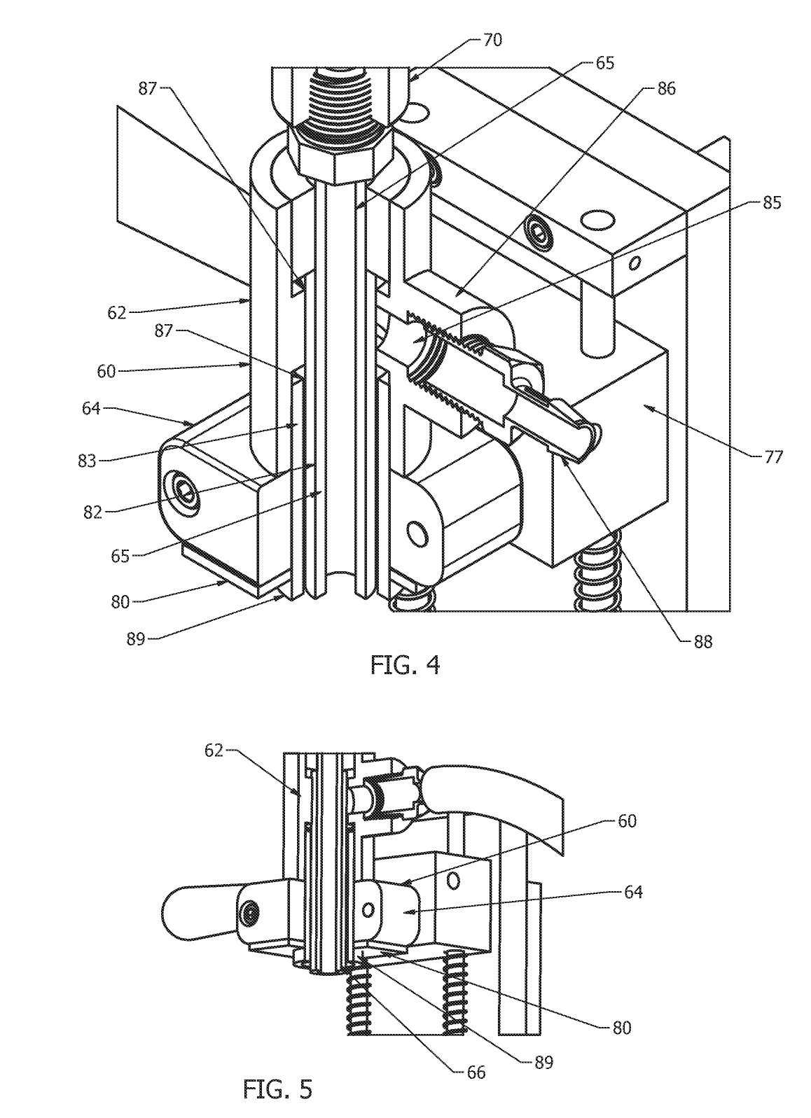

In keeping with a further feature of the illustrated embodiment, the liquid dispensing mechanism 21 includes a liquid dispensing head 60 (FIGS. 1 and 4) that is movable between a raised position for enabling positioning of a bottle 11 with its screw top spray head 12 in place into the rotatable receptacle 30 and a lowered liquid refilling position in operative relation to an open top of the bottle 11 after removal of the spray head 12. The liquid dispensing head 60 in this case is supported in elevated relation to the rotary bottle receiving rotatable receptacle 30 by a vertical support plate 61 fixed in upstanding relation to the platform plate 26 of the table 52. The illustrative liquid dispensing head 60 has a cylindrical upper body 62 and a rectangular base 64, with a central liquid direction tube 65 extending vertically through the dispensing head 60. A lower terminal end of the liquid direction tube 65 in this case protrudes from an underside of the head 60 and defines a liquid discharge orifice or nozzle 66 (FIG. 5) of the dispensing head 60 and an upper end of the liquid direction tube 65 communicates with a three directional liquid valve 70 (FIGS. 1 and 4).

The valve 70 has a first liquid inlet 71 coupled to a first liquid supply by a flexible liquid supply tube 72 through which the first liquid can be pumped to the valve 70 and a second liquid inlet 74 on an opposite side of the valve 70 for connection to a second liquid supply, which may be different from the first liquid supply, and again which can be pumped to the second liquid inlet 74 through a flexible supply tube 75 (FIG. 1). In a typical embodiment, the bottle filling system 10 may be used directly with an electrolyzing system, such as disclosed in U.S. Pat. No. 8,53,489 and International patent application PCT/US2015/063411, assigned to the same assignee as the present application, the disclosures of which are incorporated herein by reference, which simultaneously produce a hyrochlorous acid liquid sanitizer and a sodium hydroxide liquid cleaner, with the outlet for the liquid sanitizer, for example being connected to the first liquid inlet 71 of the valve 70 and the outlet for the liquid cleaner being coupled to the second liquid inlet 74. When a directional lever 78 of the valve 70 is in a central position, such as depicted in FIG. 1, both liquid inlets 71, 74 are closed from the respective liquid supplies. It will be understood that alternatively individual control valves could be used for the respective first and second liquid supply lines 72, 74.

In keeping this embodiment, the liquid dispensing head 60 is movable between a raised position that enables replacement and removal of a bottle 11 into and out of the receptacle 30 with the spray head 12 in place and a lowered position for refilling the bottle 11 with liquid following removal of the spray head 12. In this case, the liquid dispensing head 60 is mounted on a slide block 77 which has a pair of vertical slide openings extending therethrough for selected vertical movement along a pair of vertical guide rods 79. The guide rods 79 are supported between a pair of forwardly extending flanges 80 fixed in vertically spaced relation on the support plate 61. A coil spring 81 is disposed about each support rod 79 in interposed relation between the lower flange 81 and the slide block 77 for biasing the liquid dispensing head 60 in the raised position.

To facilitate movement of the liquid dispensing head 60 between the raised position and a lowered liquid filling position, the dispensing head 60 has a laterally extending handle 84 which may be manually grasped by an operator for lowering the dispensing head 60 against the biasing force of the coil springs 81 to the filling position. It will be understood that the flexible liquid inlet lines 72, 75 have a length sufficient to permit such movement of the dispensing head 60 movement during a liquid refilling cycle.

The discharge orifice or nozzle 66 of the liquid direction tube 65 of the dispensing head 60, as depicted in FIG. 5, which protrudes from the underside of the liquid dispensing head is positionable into an upper open end of a bottle 11 in the receptacle 30 during a refill cycle. The dispensing head 60 has a foam sealing gasket 80 on its underside about the liquid dispensing tube 64 for engaging and sealing the upper open end of the bottle during a refill cycle. The discharge orifice or nozzle 66 of the liquid direction tube 65 preferably has a conically tapered pointed terminal end for minimizing drippage from the tube following completion of a refilling operation.

In carrying out still a further feature of this embodiment, the liquid dispensing head 60 has an outer tube 83 disposed in concentric surrounding relation to the liquid directing tube 65 for defining an annular passageway 82 for channeling away from the bottle 11 any gasses emitted from the liquid during a refill operation as well as any overflow liquid inadvertently directed to the bottle 11. The outer tube 83 has an enlarged downstream end 89 disposed in surrounding relation to the protruding discharge end or nozzle 66 of the liquid directing tube 65 and in this case extends upwardly within the dispensing head 60 to and overflow passage 85 communicating through a right angle hub 86 of the head 60. Annular seals 87 are disposed on opposite sides of the overflow passage 85 such that any gas or liquid passing through the annular passage 82 is directed through the overflow passage 85. An overflow and gas discharge tube 88 is connected between the right angle hub 86 and the drain pipe 43 for directing drawn gasses or overflowed liquid to the drain.

In use of the bottle filling system 10, it can be seen that an operator may position an empty bottle 11 with a screw on spray head in place into the receptacle 30 of the spindle mechanism 20 (FIG. 6). With the operator holding the spray cap 14 of the spray head 12 and applying downward pressure (FIG. 7), the left foot switch may be pressed to cause the receptacle to rotate clockwise (as viewed from above) causing the bottle 11 to quickly unscrew from the spray head 12 being held against rotation by the operator. The foot switch may then be released and the disengaged spray head 12 placed aside on the table 25 (FIGS. 8 and 9).

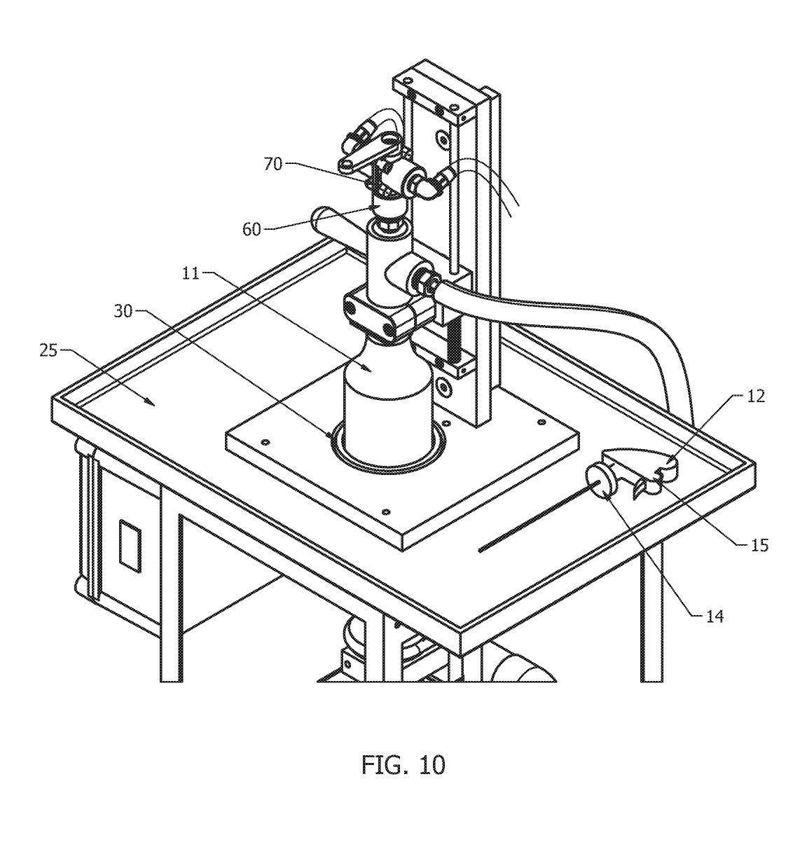

By grasping the handle 84 of the liquid dispensing head 60, the dispensing head 60 may be pulled down along the guide rods 79 against the biasing force of the springs 81 positioning the protruding nozzle 66 of the liquid directing tube 65 into the upper open end of the bottle 11 with the sealing gasket 80 on the underside of the head firmly engaging and sealing the top of the bottle 11 about the liquid direction tube 65. The operator may then actuate the lever 78 of the directional valve 70 to the appropriate side for the bottle 11 being filled (FIG. 10), for example, to the left for a liquid cleaner and to the right for a liquid sanitizer, and when the bottle 11 is full the operator may return the lever 78 to the center off position. During the refill process, it can be seen that any fumes that are emitted from the liquid dispensing to the bottle are channeled through the annular passage 82 and overflow passage 85 to the drain pipe 43. Likewise, any excess liquid inadvertently directed to the bottle 11 will pass through the overflow passage 85 to the drain pipe 43.

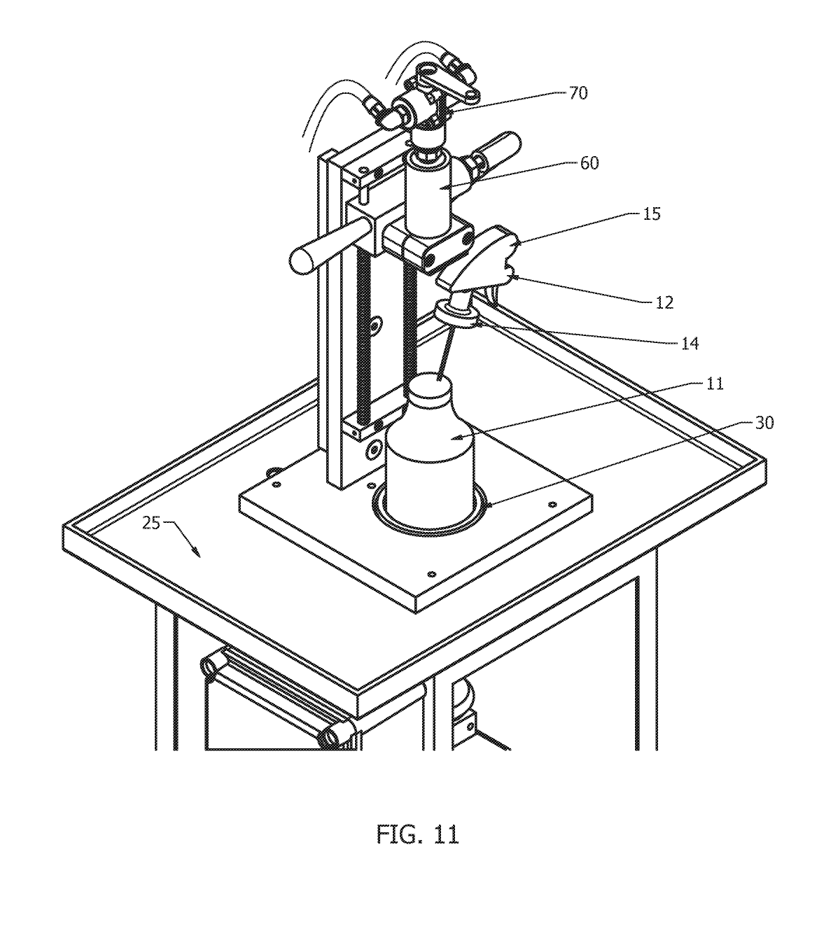

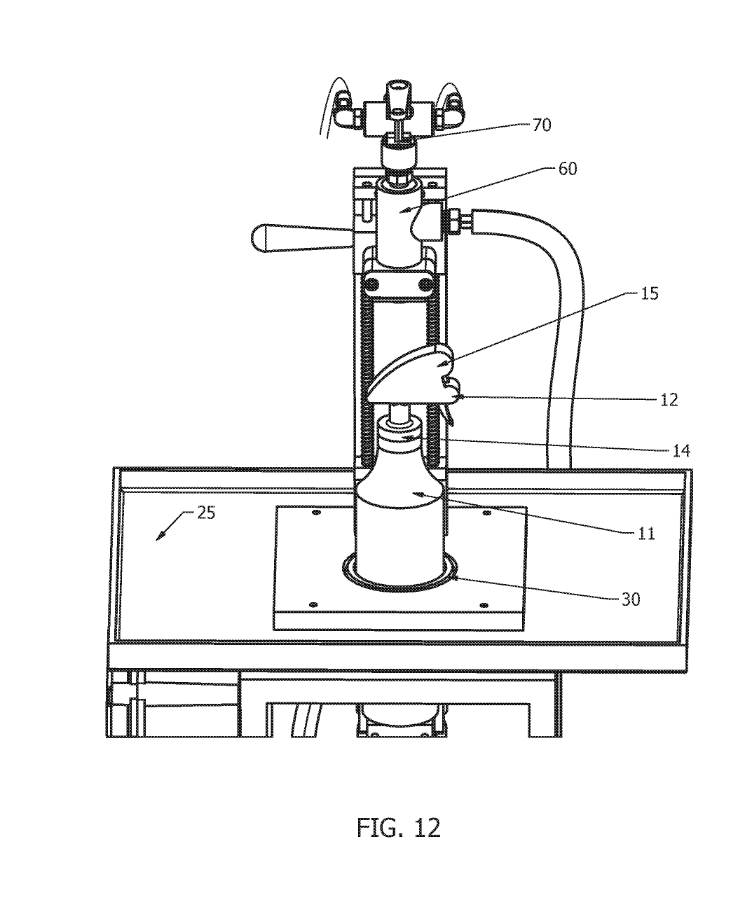

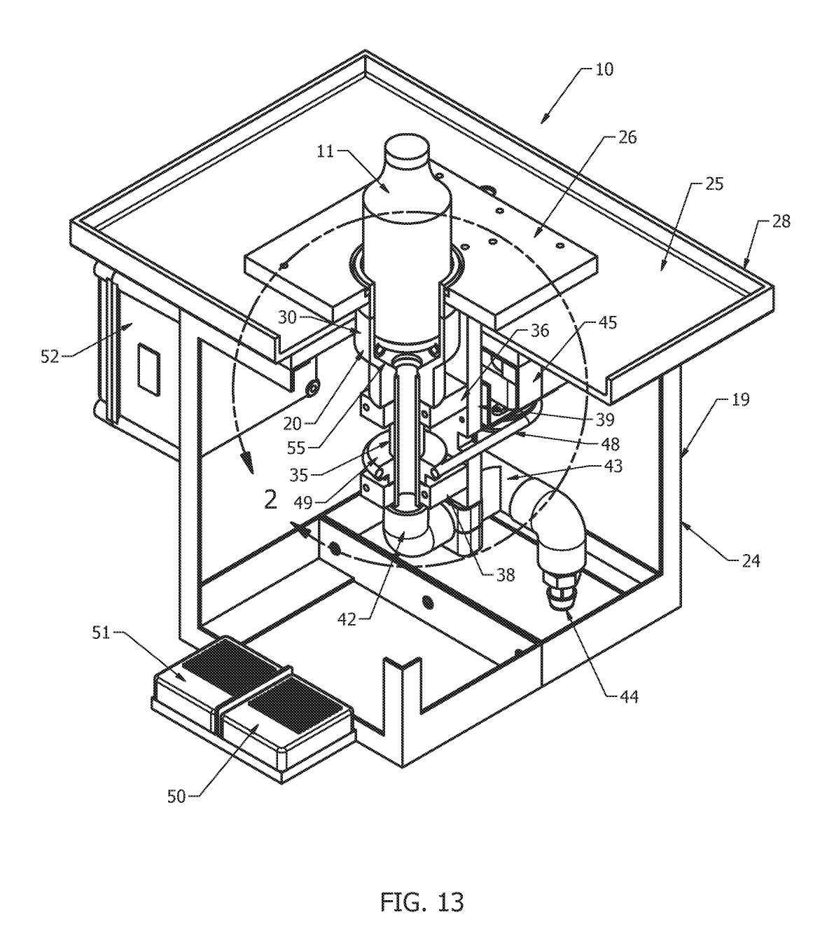

With the bottle 11 full, the operator may raise the liquid dispensing head 60 to its original upright position where it is maintained by the biasing springs 81. The operator may then reinsert the spray head 12 into the bottle 11, and then press the bottle firmly downwardly into the receptacle 30 by means of the spray head (FIGS. 11 and 12). Depressing the right foot pedal 50 will cause the bottle 11 to rotate in a counter clockwise direction, as viewed from above, causing the screw head 12 held by the operator against rotation to quickly and automatically screw back onto the bottle 11, at which time the foot switch is released. The operator may then remove the filled bottle and repeat the process until all bottles are filled. In practice, it has been found that an operator may unscrew the spray head form an empty liquid bottle, refill the bottle, and refasten the spray head in less than 20 seconds. By filling nearly 180 bottles per hour, it can be seen that the system can be operated at a rate comparable to that of more expensive and complex systems for filling multiplicities of bottles. Moreover, since the filling system of the present invention is largely automated, it can be carried out with lesser operator fatigue.

Referring now to FIG. 13 there is shown an alternative embodiment which is particularly adapted for use with systems for filling multiplicities of liquid containing bottles having screw top spray heads, such as shown in the above referenced International application PCT/US2015/063411, wherein reference numerals similar to those described above have been given similar reference numerals. As previously indicated, even in systems for simultaneously filling multiplicity of bottles, particularly time consuming aspects of the refilling process are the tasks of manually unscrewing the spray head from the bottle in preparation for refilling and then reattaching the spray head after the bottles have been filled. The spindle mechanism 20, as depicted in FIG. 13, when used in conjunction with such multiple bottle filling systems, similarly substantially shortens the refilling process. The screw top heads 12 of the bottles 11 may be quickly and easily removed and replaced by the operator in a significantly more efficient manner.

Form the foregoing, it can be seem that a system is provided for more quickly and efficiently filling individual bottles or like containers with cleaning fluid or other liquids such as used in hotels and other commercial establishments, which eliminates the need for manually screwing and unscrewing spray tops on the bottles before and after a refilling operation. The bottle filling system can be used for filling bottles at a rate comparable to, or more quickly, than more expensive and complex systems for filling multiplicities of bottles. It further minimizes the exposure to the operator of irritating or harmful fumes of cleaning fluids or other liquids that may be emitted during the refilling process. The spindle mechanism of the system also may be effectively used to substantially improve the efficiently of systems for simultaneously filling a multiplicity of reusable bottles. In either case, the system is relatively simple in construction and lends itself to economical manufacture.

1. A system for filling with liquid bottles having removable and replaceable threaded screw tops comprising:
a frame;
a bottle spindle mechanism having a bottle receiving receptacle supported by said frame for relative rotation;
a drive motor for rotating said receptacle;
said drive motor being operable for rotating said receptacle and a bottle received therein in one rotary direction while the screw top is retained against rotation for unscrewing the screw top and enabling removal of the screw top from the bottle;
a liquid dispensing mechanism coupled to a liquid supply for directing liquid into the bottle in said receptacle subsequent to removal of the screw top for filling the bottle with liquid; and
said drive motor being operable for rotating said receptacle and a bottle received therein in an opposite rotary direction subsequent to filling of the bottle with liquid and upon repositioning of the screw top on the bottle and retention of the screw top against rotation for screwing the rescrew top onto the bottle.

2. The bottle filling system of claim 1 in which said liquid dispensing mechanism includes a liquid dispensing head that is movable between (1) a raised position for enabling placement of a bottle to be filled with liquid into the receptacle with the screw top in place and removal of the bottle with the screw top replaced following filling of the bottle with liquid and replacement of the screw top and (2) a lowered bottle filling position.

3. The bottle filling system of claim 2 in which said liquid dispensing head is mounted on said frame in overlying relation to said bottle receiving receptacle.

4. The bottle filling system of claim 2 in which said liquid dispensing head has a depending liquid directing tube positionable into an open end of a bottle in said receptacle following removal of the screw top and lowering of the liquid dispensing head to said filling position.

5. The bottle filling system of claim 1 in which said bottle receiving receptacle includes an upwardly opening cylindrical section sized larger in diameter than a bottle to be received in the receptacle, a drive shaft coupled to and extending in depending relation to said cylindrical section, and said drive motor being operable for driving said drive shaft and rotating said receptacle and a bottle received therein.

6. The bottle filling system of claim 5 in which said drive shaft is hollow and communicates with said receptacle, and said hollow drive shaft communicates with a drain for directing any liquid to the drain that may spill into the receptacle during filling of the bottle.

7. The bottle filling system of claim 1 including a foot pedal operated control electrically coupled to said drive motor for enabling an operator to selectively operate the drive motor in opposite directions while manually retaining a screw top of a bottle in the receptacle against rotation.

8. The bottle filling system of claim 1 including a bottle gripping frictional element disposed in said receptacle for contact with a bottle positioned in the receptacle for facilitating rotation of the bottle simultaneously with the receptacle.

9. The bottle filling system of claim 8 in which said bottle gripping frictional element is a resilient o-ring which deforms and frictionally engages a bottle positioned in the receptacle and pressed against the o-ring.

10. The bottle filling system of claim 1 in which said receptacle has an axial length surrounding a bottle placed in the receptacle that is at least ⅓ the height of the bottle for stabilizing vertical orientation of the bottle positioned in the receptacle during removal and replacement of a screw top of the bottle.

11. The bottle filling system of claim 4 in which said dispensing head has an outer tube disposed in concentric surrounding relation to said liquid directing tube for defining an annular passageway about the liquid directing tube for channeling away from a bottle in the receptacle any gases emitted during direction of liquid into the bottle.

12. The bottle filling system of claim 4 in which said liquid dispensing head has a sealing gasket disposed in surrounding relation to the liquid dispensing tube for engaging and sealing an upper end of the bottle during the direction of liquid into the bottle.

13. The bottle filling system of claim 2 including a biasing element for biasing the liquid dispensing head in a raised direction, said head being movable to a lowered bottle filling position against the force of the biasing element.

14. A system for removing and replacing screw tops on refillable liquid containing bottles comprising:
a frame;
a bottle spindle mechanism having a bottle receiving receptacle supported by said frame for relative rotation;
a drive motor for rotating said receptacle;
said drive motor being operable for rotating said receptacle and a bottle received therein in one rotary direction while the screw top is manually retained against rotation for unscrewing the screw top from the bottle and enabling removal of the screw top from the bottle; and
said drive motor being operable for rotating said receptacle and a bottle received therein in an opposite rotary direction subsequent to filling of the bottle with liquid and upon repositioning of the screw top on the bottle and manual retention of the screw top against rotation for screwing the screw top onto the bottle.

15. The system of claim 14 including a foot pedal operated control electrically coupled to said drive motor for enabling an operator to selectively operate the motor in opposite directions while manually retaining a screw top of a bottle in the receptacle against rotation.

16. The system of claim 14 including a bottle gripping frictional element disposed in said receptacle for contact with a bottle positioned in the receptacle for facilitating rotation of the bottle simultaneously with the receptacle.

17. A method of filling with liquid bottles having removable and replaceable screw tops comprising the steps of:
providing a rotatable bottle receiving receptacle and a liquid dispensing head;
placing a bottle with a screw top in place in said receptacle;
rotating said receptacle and a bottle placed therein in one rotary direction while retaining the screw top against rotation for unscrewing the screw top from the bottle and enabling removal of the screw top from the bottle;
introducing liquid from the liquid dispensing head into the bottle in the receptacle subsequent to removal of the screw top for filling the bottle with liquid;
replacing the screw top on the bottle in the receptacle subsequent to filling with liquid and rotating the receptacle and the bottle therein in an opposite direction while retaining the screw top against rotation for resecuring the screw top on the bottle filled with liquid; and
removing the bottle filled with liquid from the receptacle.

18. The method of claim 17 including positioning the liquid dispensing head in a raised position for enabling placement of a bottle with the screw top in place in the receptacle, and lowering the liquid dispensing head to a lowered position subsequent to removal of the screw top from the bottle, introducing liquid into the bottle from the liquid dispensing head while the dispensing head is in the lowered position, and raising the liquid dispensing head to the raised position for enabling replacement of the screw top on the filled bottle while in the receptacle.

19. The method of claim 17 including manually retaining the screw top against rotation by an operator during rotation of said receptacle and a bottle placed therein as an incident to removal and replacement of a screw top on the bottle.

20. The method of claim 19 including manually controlling by operation of a foot pedal the rotation of the receptacle and a bottle received therein as an incident to removal.
